(19) United States
(12) Patent Application Publication
(10) Pub. No.: US 2008/0008520 A1
(43) Pub. Date: Jan. 10, 2008

(54) Nickel-boron coating applied to a ball bearing joint

(76) Inventors: Sumita Pal, Canton, MI (US); Michael D. Martyniak, Canton, MI (US); Willard E. Catron, New Castle, IN (US)

Correspondence Address: MCDONALD HOPKINS LLC, 600 Superior Avenue, East, Suite 2100, CLEVELAND, OH, 44114-2653, US

(21) Appl. No.: 11/804,823

(22) Filed: May 21, 2007

Related U.S. Application Data
(60) Provisional application No. 60/802,189, filed on May 19, 2006.

(51) Int. Cl. F16D 1/12; B05D 3/10

(52) U.S. Cl. 403/133; 427/305

(57) ABSTRACT

An automotive ball joint assembly includes a polymeric bearing disposed within a housing. The bearing includes an inner surface. A metallic stud includes a first end having a substantially spherical member and a second end having a shaft. The spherical member includes an outer surface capable of pivotal engagement with the bearing inner surface. A nickel-boron coating is applied to the outer surface of the spherical member to protect the spherical member against wear from friction, impact and corrosion.

### CROSS-REFERENCE TO RELATED APPLICATION

This non-provisional patent application claims the benefit of U.S. Provisional Patent Application No. 60/802,189, entitled NICKEL-BORON COATING APPLIED TO A BALL BEARING JOINT,” filed May 19, 2006, which is hereby incorporated in its entirety.

### FIELD OF THE INVENTION

The present invention relates generally to coatings utilized in ball bearing joints, and more particularly, to a nickel-boron coating applied to components within a ball bearing joint.

### BACKGROUND

Coatings are applied to a wide variety of components to change the behavior or characteristics of the surface of the component. Such components are often incorporated into an assembly, where a coating is applied to one component to change the interaction of the component relative to other components in the assembly. One such assembly is a ball bearing joint. A ball bearing joint typically includes a generally spherically-shaped ball stud surrounded by a bearing, which is captured within a housing. This arrangement provides for the ball stud to rotate relative to the bearing, such that rotational motion of the ball stud may be transferred to any structure that is attached to the ball stud or visa versa. Such ball bearing joints are used in a variety of industries, for example, the automobile industry. The automobile industry uses ball bearing joints for a number of applications, such as vehicle steering systems, suspension systems, and the like.

A ball bearing joint is typically arranged such that the outside surface of the ball stud and the inside surface of the bearing are in contact. As the ball stud rotates, its surface moves along the surface of the bearing, which can cause wear and other damage to the surfaces due to friction or the grinding of foreign particles between the surfaces. Such damage may accumulate over time, causing the joint to perform less efficiently and may lead to failure of the joint. To reduce damage due to friction, the outside surface of the ball stud and inside surface of the bearing may be fabricated or coated to produce relatively low coefficients of friction on the opposing surfaces. In addition, lubricants may be applied between the surfaces of the ball stud and bearing to reduce friction.

Although the application of coatings and lubricants within a ball bearing joint is intended to increase service life of such joints by decreasing wear and other damage, when components are fabricated from metal, the service life of the joint may be compromised by rust or other corrosion forming on the metal components. Metal components can be susceptible to the formation of corrosion due to the intrusion of moisture into the joint. In many ball bearing joint applications, such as those in the automobile industry, moisture cannot be avoided. For example, an automobile is designed to operate in all types of weather and environmental conditions, including rain, sleet, and snow. Some vehicles, such as jeeps and sport utility vehicles, are even designed such that the chassis of the vehicle is frequently submerged as the vehicle traverses a body of water.

When rust particles form on the surface of the ball stud or the bearing, the particles can cause damage to the opposing surface. Rust particles typically have an abrasive nature. When rust forms on a surface, the interaction between that surface and an opposing surface is altered. The coefficient of friction of a rusted portion is typically substantially higher than the coefficient of friction of non-corroded portions of the surface. This higher coefficient of friction increases the force needed to move the ball stud with respect to the bearing, thus, making the joint less efficient. In addition, as a rusted or otherwise corroded portion comes into contact with the opposing surface, the opposing side may sustain scratches, chips, or other similar damage due to the abrasive nature of the rusted portion. Rust particles that form on a metal surface also tend to flake away from the surface. This produces rust particles that may float or otherwise suspend in the lubricant and may become lodged between the surface of the ball and the surface of the bearing. As the surfaces move relative to one another, particles of rust lodged between the surfaces may cause damage to both surfaces.

Ball bearing joints are designed and fabricated such that the surface finish on the engaging portions of the ball stud and bearing has relatively lower coefficients of friction. Due to wear and corrosion on metal surfaces within ball bearing joints, the surface finishes may experience increases in coefficients of friction, scratches, chips, and similar damage over time. This may lead to loss of efficiency of the joint and, eventually, failure of the ball bearing joint. Therefore, there is a need in the art for coatings that offer lower initial coefficients of friction, along with coatings that offer greater resistance to rust and other corrosion. Such improvements may provide for the surface finishes of the engaging portions of the ball stud and bearing to remain in serviceable condition for extended periods of time, thus, extending the service life of the ball bearing joint.

### SUMMARY OF THE INVENTION

An embodiment of the present invention provides for an automotive ball joint assembly. The ball joint includes a polymeric bearing disposed within a housing. The bearing includes an inner surface. A metallic stud includes a first end having a substantially spherical member and a second end having a shaft. The spherical member includes an outer surface capable of pivotal engagement with the bearing inner surface. A nickel-boron coating is applied to the outer surface of the spherical member to protect the outer surface against wear from friction, impact and corrosion.

### BRIEF DESCRIPTION OF THE SEVERAL VIEWS OF THE DRAWING

Objects and advantages together with the operation of the invention may be better understood by reference to the following detailed description taken in connection with the following illustration, wherein:

FIG. 1 shows a cross-sectional view of a ball bearing joint in accordance with the present invention.

### DETAILED DESCRIPTION OF THE INVENTION

The above-identified disadvantages of the prior art are overcome through the use of the invention disclosed herein. By applying coatings with lower initial coefficients of friction, which are also resistant to the formation of rust and other corrosion, the service life of a ball bearing joint may be extended.

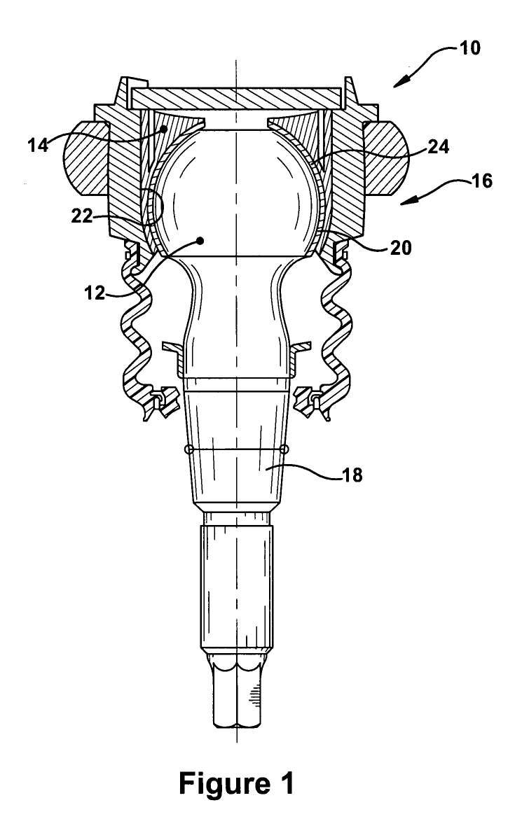

Referring to FIG. 1, an exemplary ball bearing joint 10 is illustrated. The ball bearing joint 10 includes a ball stud 12 engaged with a bearing 14. The ball stud 12 and bearing 14 are captured within a housing 16. The housing 16 is arranged around the bearing 14 such that the bearing 14 is fixed with respect to the housing 16.

A relatively thin coating 24 is applied to the outer surface 20 of the ball stud 12. In the exemplary embodiment, the coating is a nickel-boron alloy (hereinafter “Ni-B coating”) deposited on the ball stud through an electroless plating process. This alloy and process for applying the alloy, along with other alloys and processes suitable for use with the present invention, are described in U.S. Pat. No. 6,066,406 to McComas, granted May 23, 2000; U.S. Pat. No. 6,183,546 to McComas, granted Feb. 6, 2001; U.S. Pat. No. 6,319,308 to McComas, granted Nov. 20, 2001; and U.S. Pat. No. 6,782,650 to McComas, granted Apr. 31, 2004, all of which are incorporated herein by reference in their entirety.

The ball stud 12 is positioned within the bearing 14 such that an outer surface 20 of the ball 12 is in contact with an inner surface 22 of the bearing 14, whereby the ball stud 12 may rotate or otherwise move with respect to the bearing 14. In the exemplary embodiment, a shaft 18 extends from the ball stud 12 to which additional components or structures may be coupled. The shaft 18 provides for the motion of the ball stud 12 to be transferred to components or structure coupled to the shaft 18. For example, in an exemplary automotive application, the stud 12 may be coupled to a steering knuckle and the housing 16 may be coupled to a control arm. Another example is a steering outer tie rod assembly wherein the stud 12 may be coupled to a steering knuckle and the housing 16 may be coupled to the tie rod. Other examples include single and double suspension linkage assemblies wherein the ball stud 12 couples to the knuckle and the housing 16 couples with the linkage

Optionally, a lubricating substance (not shown in FIG. 1) may be disposed between the outer surface 20 of the ball stud 12 and the inner surface 22 of the bearing 14. The lubricating substance may be a “wet” lubricant, such as an oil or silicone-based grease or the like, or a “dry” lubricant, such as tungsten disulfide, moly disulfide, PTFE, or the like. In addition, the lubricating substance may be blasted into the Ni—B coating with high pressure, rubbed or burnished into the Ni—B coating, or the like.

The exemplary ball stud 12 is manufactured or fabricated from steel and the exemplary bearing 14 is manufactured or fabricated from a polymeric material. However, other known materials may be used. Additionally, although the present invention is described as including a steel ball stud coated with a nickel-boron alloy and a polymeric bearing, it should be readily understood to those skilled in the art that this is simply an exemplary arrangement and other arrangement are included in the present invention. For example, arrangements where the bearing is fabricated from metal and coated with an alloy and the ball stud is fabricated from a polymeric material, or where both the bearing and ball stud are steel and coated with an alloy are included in the present invention. Moreover, it will be appreciated that either or both the bearing and the stud may be fabricated from a polymeric material and either or both polymeric components coated with an alloy.

The nickel-boron alloy coating and similar alloy coatings described in the above referenced patents offer a number of properties and features that can extend the service life of a ball bearing joint. When deposited, Ni—B coatings form relatively smooth surface finishes and are responsive to further smoothening by polishing of the surface. Such smooth finishes may provide relatively low coefficients of friction. These low coefficients of friction may reduce wear and other damages to both the Ni—B coated surface and any surface engaged by the Ni—B coated surface. In addition, Ni—B coatings offer relatively hard surfaces. Such hard surfaces resist scratching, chipping, and other such damage. The smooth low friction of a Ni—B coated surface and the hardness of the surface each contribute to limiting wear and other damage to the surfaces of the ball stud and bearing, and may extend the service life of the ball bearing joint.

Ni—B coatings are highly rust and corrosion resistant. This resistance reduces sensitivity to moisture intrusion into the joint. By resisting the formation of rust or other corrosion on steel components within the ball bearing joint, damage due to corrosion can be either eliminated or substantially reduced. The corrosion resistance increases the service life of the ball bearing joint by eliminating or limiting damage sustained by the surfaces over time.

When deposited as described herein, Ni—B coatings form columnar structures. Such structures enhance the ability of the surface to retain lubricants, such as grease, disposed between the ball stud and the bearing. This enhanced lubricant retention, coupled with the generally lower coefficients of friction of Ni—B coated surfaces, reduces the reliance on grease and other such lubricants. The quantity of lubricant disposed in the ball bearing joint can thus be reduced without a significant impact on the performance or service life of the ball bearing joint, which can lead to cost savings in the manufacture and maintenance of the ball bearing joint.

While the invention has been described with reference to the preferred embodiment, other embodiments, modifications, and alternations may occur to one skilled in the art upon reading and understanding of this specification and are to be covered to the extent that they fall within the scope of the appended claims. Indeed, the invention as described by the claims is broader than and unlimited by the preferred embodiment, and the terms in the claims have their full and ordinary meaning.

Having thus described the invention, we claim:

1. An automotive ball joint assembly comprising:
a housing;
a polymeric bearing disposed within said housing, said bearing having an inner surface;
a metallic stud comprising a first end having a substantially spherical member and a second end a having a shaft, said spherical member comprising an outer surface capable of pivotal engagement with said bearing inner surface; and
a nickel-boron coating applied to said spherical member outer surface to protect said member against wear from friction, impact and corrosion.

2. The joint of claim 1 wherein said coating is electrolessly deposited.

3. The joint of claim 1 wherein coating comprises a columnar structure.

4. The joint of claim 3 further comprising a lubricant disposed between said bearing inner and spherical member outer surfaces.

5. The joint of claim 1 wherein said coating is polished.

6. The joint of claim 1 wherein said housing is coupled to an automotive control arm and said shaft is coupled to an automotive steering knuckle.

7. An automotive ball joint assembly comprising:
a housing;
a bearing disposed within said housing, said bearing having an inner surface;
a stud comprising a first end having a substantially spherical member and a second end a having a shaft, said spherical member comprising an outer surface capable of pivotal engagement with said bearing inner surface; and
a nickel-boron coating applied to at least one of said bearing inner and spherical member outer surfaces to protect said surface against wear from friction, impact and corrosion.

8. The joint of claim 7 wherein said coating is electrolessly deposited.

9. The joint of claim 7 wherein coating comprises a columnar structure.

10. The joint of claim 9 further comprising a lubricant disposed between said bearing inner and spherical member outer surfaces.

11. The joint of claim 7 wherein said bearing comprises a polymer.

12. The joint of claim 7 wherein said stud comprises a metal.

13. The joint of claim 7 wherein said coating is polished.

14. The joint of claim 7 wherein said housing is coupled to an automotive control arm and said shaft is coupled to an automotive steering knuckle.
